(19) United States
(12) Patent Application Publication
(10) Pub. No.: US 2005/0047619 A1
(43) Pub. Date: Mar. 3, 2005

(54) Apparatus, method, and program for creating all-around acoustic field

(75) Inventors: Hisako Murata, Kanagawa-ken (JP); Naoko Yurino, Kanagawa-ken (JP); Miki Haneishi, Kanagawa-ken (JP); Takuma Suzuki, Kanagawa-ken (JP)

Correspondence Address: CONNOLLY BOVE LODGE & HUTZ LLP, SUITE 800, 1990 M STREET NW, WASHINGTON, DC, 20036-3425, US

(73) Assignee: VICTOR COMPANY OF JAPAN, LTD., Kanagawa-ken (JP)

(21) Appl. No.: 10/925,959

(22) Filed: Aug. 26, 2004

(30) Foreign Application Priority Data
Aug. 26, 2003 (JP) 2003-300935
Oct. 27, 2003 (JP) 2003-365621
Jun. 30, 2004 (JP) 2004-192920

(51) Int. Cl. H04R 5/00; H04R 5/02

(52) U.S. Cl. 381/309; 381/17

(57) ABSTRACT

In an apparatus for creating an all-around acoustic field, a producing section (4) is composed of a selecting section (41) for selecting one pair of right and left head transfer functions at an angle corresponding to an arriving direction of a reflected sound out of data of head transfer functions in whole directions stored in a storage section (5) on the basis of data of arriving directions of reflected sounds, an equalizing section (42) for equalizing a pair of right and left head transfer functions selected by the selecting section (41) by using frequency characteristic data of reflected sounds, a delaying section (43) for delaying the pair of right and left head transfer functions equalized by the equalizing section (42) by using delay time until a reflected sound arrives at a sound receiving point, and an adding section (44) for obtaining two channels of right and left impulse responses by accumulating the delayed pair of right and left head transfer responses.

### BACKGROUND OF THE INVENTION

1. Field of the Invention:

The present invention relates to an apparatus, a method, and a program for creating an all-around acoustic field that conducts to reproduce an acoustic field of an incoming audio signal on the basis of analyzed data of an acoustic field at a sound receiving point designated in a space to be objected for reproducing the acoustic field.

2. Description of the Related Art:

Until now, through a digital signal processing technology, an audio-visual (AV) amplifier has realized an acoustic field that impressed an audience as if he was listening in a concert hall. There existed some methods for producing atmosphere of an acoustic field such as, for example, adding reverberation components through a reverb processing method in old times, or previously calculating conditions of reflected sounds in a concert hall and setting a reflected sound in individual directions to a coefficient of a so-called FIR (finite impulse response) filter, and then a sound of each channel is processed through an FIR filter.

Further, in the case of viewing a movie by means of a so-called home theater system, recently, there existed a home theater system, which reproduces sounds to be emitted from surround left and right loudspeakers of a movie theater by front two channel loudspeakers through a virtual sound source.

However, in any case of signal processing methods that are commonly conducted by AV amplifiers, a direction of a sound source is directed by a set of loudspeakers to be installed, or by right and left surround loudspeakers to be installed in case of a virtual sound source. Consequently, any of the conventional signal processing methods never reproduces an acoustic field that we experience daily. In other words, the signal processing methods not always reproduce an acoustic field in which we can hear sounds in all-around directions.

On the other hand, in order to predict various kinds of acoustic fields such as athletic fields, studios and home theaters as well as theaters and halls, an acoustic simulation is carried out by calculating indoor acoustic field characteristics such as sound level at a sound receiving point through the commonly known image method or sound ray tracking method once sound pressure energy or sound pressure level in a limited band width is obtained as data of a loudspeaker or a sound source.

The Japanese Patent Application Laid-open Publication No. 2002-366162, titled “Sound Simulation Device and Sound Controller”, discloses the system that reproduces tones by accurately predicting an acoustic field including phase characteristics and by calculating impulse response data at a sound receiving point by using impulse response data in whole directions of a loudspeaker as a sound source.

Further, the Japanese Patent No. 2932801, titled “Stereophonic Sound Field Simulation Method”, discloses the method of creating a simulative acoustic field by predicting acoustic characteristics of an acoustic field, which has never realized, that is, which has never existed actually.

According to the above-mentioned method of creating a simulative acoustic field, an impulse response corresponding to a specific direction or a solid angle is obtained, and acoustic characteristics of right and left ears are compensated and separated into two channels, and then an impulse response equivalent to some minutes of the solid angle is synthesized or added with respect to each of the right and left ears. These processes are conducted by the undulatory acoustic simulation method or arithmetic operation. In the case of listening to the simulated acoustic field, the synthesized impulse response is reproduced through right and left loudspeakers while the crosstalk canceling process including compensation of the reproducing system is applied.

The Japanese Patent No. 2932801 teaches that respective impulse responses enable to be accurately inputted into right and left ears of an audience by the simulation method, and resulting in creating a stereophonic acoustic field.

Further, it teaches that increasing a number of dispersions of a solid angle makes accuracy higher, wherein “a number of dispersions” is supposed to be misprinting of “a number of divisions”.

According to the inventive concept disclosed in the Japanese Patent Application Laid-open Publication No. 2002-366162, when conducting to make audible, each impulse response of each sound ray and a head transfer function corresponding to an incident angle to a receiving point are processed by the convolution operation, and resulting in producing two channels of right and left transfer functions. However, it fails to teach an actual method for producing the two channels of right and left transfer functions, that is, two channels of right and left impulse responses.

Further, when producing a wall transfer function, the inventor paid attention only to the frequency response, so that he neglected delay time of a reflected sound, which reached to the sound receiving point.

According to the inventive concept disclosed in the Japanese Patent No. 2932801, synthesizing or adding impulse responses is performed by numerical operations, so that it takes long period of time to sound actually after calculation has been started. In the numerical operations, an impulse response is obtained by dividing a solid angle into variables accordingly. Consequently, the more a number of divisions is increased in order to improve accuracy, the more it takes time to sound actually after the calculation has been started.

Further, according to the methods of the above-mentioned prior arts, sounds are integrated into two channels of right and left and reproduced by two front loudspeakers. However, it is hard to reproduce such a situation that sounds transmit throughout a concert hall and the concert hall resonates totally as if the concert hall transformed into a resonance box or a resonator as we can actually experience in a concert hall.

### SUMMARY OF THE INVENTION

Accordingly, in consideration of the above-mentioned problems of the prior arts, an object of the present invention is to provide an apparatus, a method, and a program for creating an all-around acoustic field, which faithfully reproduce an acoustic field of a concert hall through a method intending to shorten processing time, particularly, reproduce arriving directions of direct sounds and reflected sounds and delay time of arrival, and resulting in enabling to reproduce an acoustic field in higher realistic sensations.

Further, another object of the present invention is to provide an apparatus, a method, and a program for creating an all-around acoustic field, which enable to reproduce a situation such that sounds transmit throughout a concert hall and the concert hall resonates totally as if the concert hall transformed into a resonance box or a resonator by conducting lower frequencies to be an exclusive channel, that is, a situation of sounding all-around.

In order to achieve the above object, the present invention provides, according to an aspect thereof, an apparatus for creating an all-around acoustic field, producing an acoustic field with respect to incoming audio signals on the basis of analyzed data of an acoustic field at a sound receiving point designated in a space to be objected for reproducing the acoustic field, comprising: storage means for storing data of head transfer functions in whole directions at respective positions of both ears of a human head; producing means for producing two channels of right and left impulse responses by replacing a direct sound and each reflected sound at the sound receiving point with a pair of right and left head transfer functions by using the analyzed data of an acoustic field and the data of head transfer functions in whole directions; and acoustic field processing means for processing to reproduce an acoustic field with respect to the incoming audio signals by using the two channels of right and left impulse responses produced by the producing means, the producing means further characterized by comprising; selecting means for selecting data of one pair of right and left head transfer functions of the direct sound at an angle corresponding to an arriving direction of the direct sound out of the data of head transfer functions in whole directions on the basis of data of arriving directions of direct sounds as the analyzed data of an acoustic field at the sound receiving point, and for selecting data of a pair of right and left head transfer functions with respect to the each reflected sound at an angle corresponding to an arriving direction of the each reflected sound out of the data of head transfer functions in whole directions on the basis of data of arriving directions of each reflected sound as the analyzed data of an acoustic field at the sound receiving point; equalizing means for equalizing the pair of right and left head transfer functions selected by the selecting means with respect to the selected direct sound on the basis of data of frequency characteristics of a direct sound at the sound receiving point as the analyzed data of an acoustic field, and for equalizing the selected pair of right and left head transfer functions with respect to the selected each reflected sound on the basis of the data of frequency characteristics of a reflected sound at the sound receiving point as the analyzed data of an acoustic field; delaying means for delaying a pair of right and left head transfer functions with respect to the equalized direct sound on the basis of data of arrival delay time of a direct sound at the sound receiving point as the analyzed data of an acoustic field, and for delaying a pair of right and left head transfer functions with respect to the equalized each reflected sound on the basis of data of arrival delay time of a reflected sound at the sound receiving point as the analyzed data of an acoustic field; and adding means for obtaining the two channels of right and left impulse responses by adding the delayed data of the pair of right and left head transfer functions obtained with respect to the direct sound to the delayed data of the pair of head transfer functions obtained with respect to the each reflected sound equivalent to a number of sound rays of reflected sounds in each of the right and left channels respectively.

According to another aspect of the present invention, there provided a method for creating an all-around acoustic field, producing an acoustic field with respect to incoming audio signals on the basis of analyzed data of an acoustic field at a sound receiving point designated in a space to be objected for reproducing the acoustic field, comprising steps of: storing data of head transfer functions in whole directions at respective positions of both ears of a human head; producing two channels of right and left impulse responses by replacing a direct sound and each reflected sound at the sound receiving point with a pair of right and left head transfer functions by using the analyzed data of an acoustic field and the data of head transfer functions in whole directions; and processing to reproduce an acoustic field with respect to the incoming audio signals by using the two channels of right and left impulse responses produced in the step of producing, the step of producing the two channels of right and left impulse responses further characterized by comprising steps of: selecting data of one pair of right and left head transfer functions of the direct sound at an angle corresponding to an arriving direction of the direct sound out of the data of head transfer functions in whole directions on the basis of data of arriving directions of direct sounds as the analyzed data of an acoustic field at the sound receiving point, and for selecting data of a pair of right and left head transfer functions with respect to the each reflected sound at an angle corresponding to an arriving direction of the each reflected sound out of the data of head transfer functions in whole directions on the basis of data of arriving directions of each reflected sound as the analyzed data of an acoustic field at the sound receiving point; equalizing the pair of right and left head transfer functions selected in the step of selecting with respect to the selected direct sound on the basis of data of frequency characteristics of a direct sound at the sound receiving point as the analyzed data of an acoustic field, and for equalizing the selected pair of right and left head transfer functions with respect to the selected each reflected sound on the basis of the data of frequency characteristics of a reflected sound at the sound receiving point as the analyzed data of an acoustic field; delaying a pair of right and left head transfer functions with respect to the equalized direct sound on the basis of data of arrival delay time of a direct sound at the sound receiving point as the analyzed data of an acoustic field, and for delaying a pair of right and left head transfer functions with respect to the equalized each reflected sound on the basis of data of arrival delay time of a reflected sound at the sound receiving point as the analyzed data of an acoustic field; and adding to obtain the two channels of right and left impulse responses by adding the delayed data of the pair of right and left head transfer functions obtained with respect to the direct sound to the delayed data of the pair of head transfer functions obtained with respect to the each reflected sound equivalent to a number of sound rays of reflected sounds in each of the right and left channels respectively.

According to a further aspect of the present invention, there provided a program for creating an all-around acoustic field, making a computer function as an apparatus for creating an all-around acoustic field for producing an acoustic field with respect to incoming audio signals on the basis of analyzed data of an acoustic field at a sound receiving point designated in a space to be objected for reproducing the acoustic field, wherein the computer is realized by the program to comprise: producing means for producing two channels of right and left impulse responses by replacing a direct sound and each reflected sound at the sound receiving point with a pair of right and left head transfer functions by using data of head transfer functions supplied from a memory storing the analyzed data of an acoustic field and data of head transfer functions in whole directions at respective positions of both ears of a human head; and acoustic field processing means for processing to reproduce an acoustic field with respect to the incoming audio signals by using the two channels of right and left impulse responses produced by the producing means, the producing means further characterized by comprising: selecting means for selecting data of one pair of right and left head transfer functions of the direct sound at an angle corresponding to an arriving direction of the direct sound out of the data of head transfer functions in whole directions on the basis of data of arriving directions of direct sounds as the analyzed data of an acoustic field at the sound receiving point, and for selecting data of a pair of right and left head transfer functions with respect to the each reflected sound at an angle corresponding to an arriving direction of the each reflected sound out of the data of head transfer functions in whole directions on the basis of data of arriving directions of each reflected sound as the analyzed data of an acoustic field at the sound receiving point; equalizing means for equalizing the pair of right and left head transfer functions selected by the selecting means with respect to the selected direct sound on the basis of data of frequency characteristics of a direct sound at the sound receiving point as the analyzed data of an acoustic field, and for equalizing the selected pair of right and left head transfer functions with respect to the selected each reflected sound on the basis of the data of frequency characteristics of a reflected sound at the sound receiving point as the analyzed data of an acoustic field; delaying means for delaying a pair of right and left head transfer functions with respect to the equalized direct sound on the basis of data of arrival delay time of a direct sound at the sound receiving point as the analyzed data of an acoustic field, and for delaying a pair of right and left head transfer functions with respect to the equalized each reflected sound on the basis of data of arrival delay time of a reflected sound at the sound receiving point as the analyzed data of an acoustic field; and adding means for obtaining the two channels of right and left impulse responses by adding the delayed data of the pair of right and left head transfer functions obtained with respect to the direct sound to the delayed data of the pair of head transfer functions obtained with respect to the each reflected sound equivalent to a number of sound rays of reflected sounds in each of the right and left channels respectively.

Other object and further features of the present invention will be apparent from the following detailed description when read in conjunction with the accompanying drawings.

### BRIEF DESCRIPTION OF DRAWINGS

FIG. 1 is a block diagram of an apparatus for creating an all-around acoustic field according to a first embodiment of the present invention.

FIG. 2 is a block diagram exhibiting a constitution of a producing section shown in FIG. 1.

FIG. 3 is a flow chart showing total processes conducted in the apparatus shown in FIGS. 1 and 2.

FIG. 4 is a configurational diagram exhibiting relationship between a sound source and a sound receiving point according to the present invention, wherein data of head transfer functions in whole directions are measured and stored in a storage section shown in FIG. 1.

FIG. 5 shows a program configuration of a CD-EXTRA disc according to a second embodiment of the present invention.

FIG. 6 shows a program configuration of a DVD-AUDIO disc according to a third embodiment of the present invention.

FIG. 7 is a block diagram of a DVD encoder to be applied for an apparatus for creating all-around acoustic field according to the third embodiment of the present invention.

FIG. 8 is a block diagram of an apparatus for creating an all-around acoustic field according to a fourth embodiment of the present invention.

FIG. 9 is a flow chart showing total processes conducted in the apparatus shown in FIG. 8.

### DETAILED DESCRIPTION OF THE PREFERRED EMBODIMENTS

[First Embodiment]

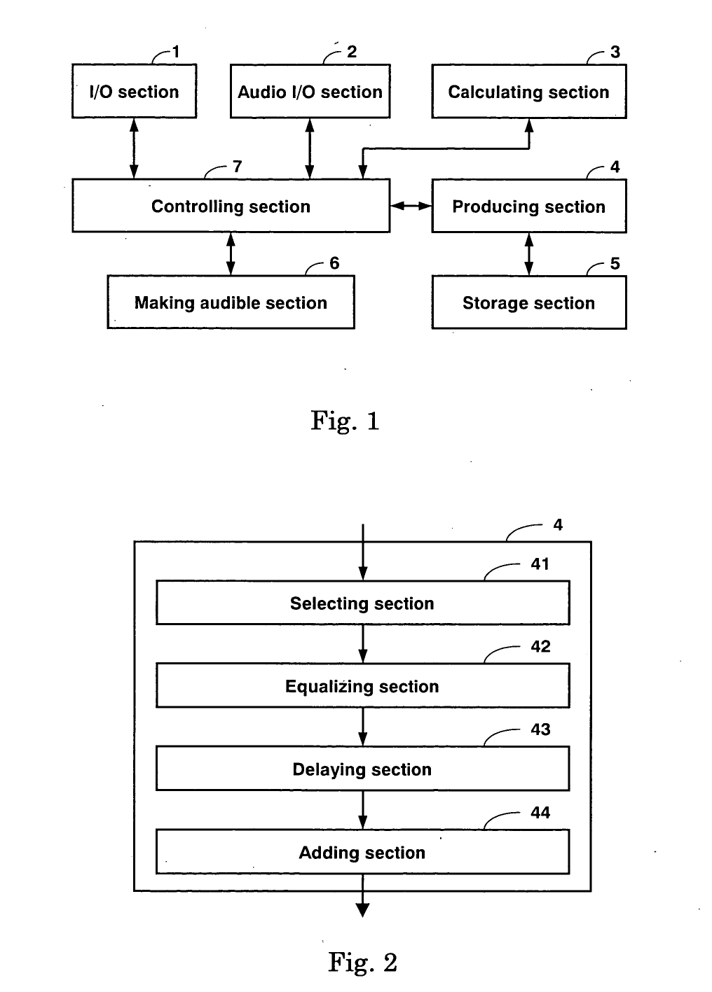

FIG. 1 is a block diagram of an apparatus for creating an all-around acoustic field according to a first embodiment of the present invention.

FIG. 2 is a block diagram exhibiting a constitution of a producing section for impulse response shown in FIG. 1.

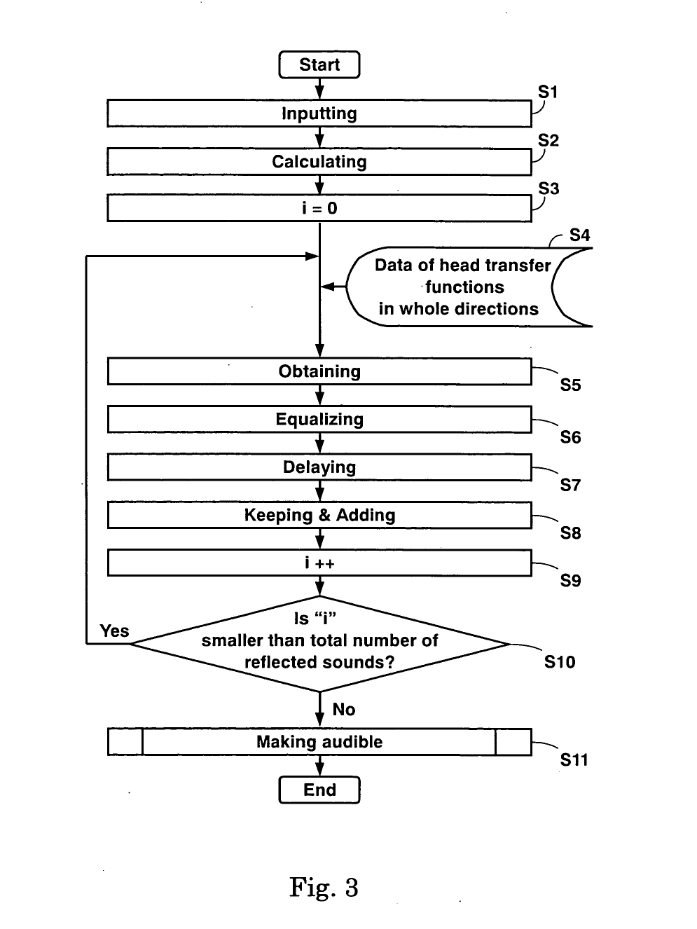

FIG. 3 is a flow chart showing total processes conducted in the apparatus shown in FIG. 1.

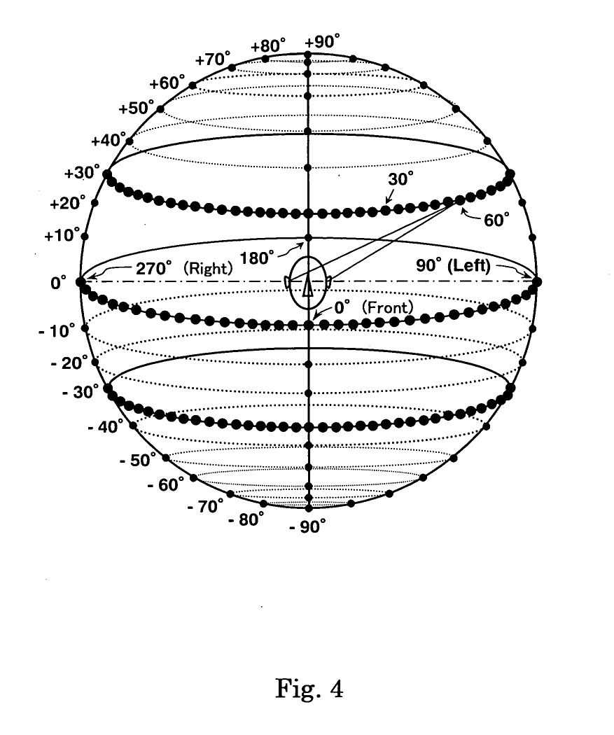

FIG. 4 is a configurational diagram exhibiting relationship between a sound source and a sound receiving point according to the present invention, wherein data of head transfer functions in whole directions are measured and stored in a storage section shown in FIG. 1.

In FIG. 1, an apparatus for creating an all-around acoustic field is composed of an input/output section (hereinafter referred to as I/O section) 1, an audio input/output section (hereinafter referred to as audio I/O section) 2, a calculating section 3 for calculating reflected sounds, a producing section 4 for producing an impulse response, a storage section 5 for storing head transfer functions in whole directions, a making audible section 6 and a controlling section 7. The I/O section 1 is provided with an input device for inputting chamber configuration data to obtain information about reflected sounds and a coordinate of a sound receiving point, and an output device for displaying results. The audio I/O section 2 is an input and output device necessary for sounds when making them audible. A number of input channels is one channel in case a sound source is designated to be one. In a case that a sound source is designated to be two, a number of input channels is two channels. A number of output channels is two channels such as one set of headphones or two loudspeakers, for example. The calculating section 3 is used for calculating total reflected sounds including direct sounds at an sound receiving point allocated in a space to be an object of creating an acoustic field. The producing section 4 produces two channels of right and left impulse responses. While producing impulse responses, the producing section 4 utilizes a pair of right and left head transfer functions stored in the storage section 5. The making audible section 6 makes audio signals inputted by the audio I/O section 2 audible by using right and left impulse responses that are produced in the producing section 4. In other words, the making audible section 6 is an acoustic field processing section for processing inputted audio signals. The controlling section 7 controls these sections totally.

As shown in FIG. 2, the producing section 4 for producing an impulse response is further composed of a selecting section 41 for selecting a head transfer function, an equalizing section 42, a delaying section 43 and an adding section 44. The selecting section 41 selects a pair of right and left head transfer functions at an angle corresponding to an arriving direction of a reflected sound out of head transfer function data in whole directions stored in the storage section 5 in accordance with data of arriving directions of reflected sounds. The equalizing section 42 equalizes the pair of right and left head transfer functions selected by the selecting section 41 by using frequency characteristic data of reflected sounds. The delaying section 43 conducts to delay the pair of right and left head transfer functions equalized by the equalizing section 42 by using delay time until a reflected sound arrives at a sound receiving point. The adding section 44 obtains two channels of right and left impulse responses by accumulating the pair of right and left head transfer functions delayed by the delaying section 43.

Head transfer functions in whole directions are such a head transfer function that a plurality of sound sources are allocated in all-around directions surrounding a human head. In the case of the first embodiment of the present invention, imaging a celestial sphere having a radius of one meter with centering a human head is easy to understand a configuration of an all-around acoustic field. As shown in FIG. 4, loudspeakers are allocated at every 10 degrees in the elevation angle and at every 5 degrees in the horizontal angle, and then data of impulse responses at both ears are measured and stored as a file. In this connection, 72 loudspeakers in total are allocated on one horizontal plain at every 5 horizontal degrees in a circle. In FIG. 4, it is defined that a file name of data measured with respect to a loudspeaker allocated at 30 degrees in the elevation angle and 60 degrees in the horizontal angle, for example, is “R30e60a.raw” for the right ear and “L30e60a.raw” for the left ear respectively. A pair of right and left head transfer functions is one set of data. When the respective data of the “R30e60a.raw” and the “L30e60a.raw” are supplied as sounds to the right and left ears respectively, the impulse enables to be heard in the direction at 60 degrees in the elevation angle and 30 degrees in the horizontal angle.

There is no standard for an angle to measure an impulse response. The angle enables to be wider a little more than the angle defined in the first embodiment of the present invention as mentioned above, unless there is no difference in a noticeable direction although the angle is defined as 10 degrees in the elevation angle and 5 degrees in the horizontal angle in the first embodiment of the present invention.

A basic principle of measuring an impulse response is briefly explained hereupon, wherein a sound receiving point is defined as just one point when calculating a reflected sound.

Further, when a direct sound and reflected sounds at the sound receiving point are calculated, it is assumed that a reflected sound comes from a direction at 30 degrees in the elevation angle and 60 degrees in the horizontal angle. In this particular case, it is a major subject matter of the present invention that the reflected sound is replaced by the above-mentioned pair of right and left impulse responses at 30 degrees in the elevation angle and 60 degrees in the horizontal angle.

With referring to FIGS. 1 to 3, further details of the first embodiment are explained next. First of all, in order to configure a chamber shape of an objective concert hall, that is, a space to be an object of reproducing an acoustic field, chamber shape data and data of sound absorbing ratios of interior materials furnished on wall surfaces are inputted through the I/O section 1 (a step S1 in FIG. 3).

Further, data of positions of a sound source and a sound receiving point are inputted through the I/O section 1 (S1), wherein the sound source and the sound receiving point is defined as only one respectively. When inputting all data necessary for obtaining information about reflected sounds is completed, the controlling section 7 conducts the calculating section 3 to calculate a reflected sound at the sound receiving point. In this first embodiment, the calculating section 3 calculates all sound rays arriving at the sound receiving point from the sound source based on the geometrical acoustics. In this bout, following three kinds of data or acoustic field analyzing data are calculated (S2):
(1) Arriving directions of a direct sound and reflected sounds arriving at the sound receiving point, that is, data of a horizontal angle and an elevation angle,
(2) Frequency characteristic data reflecting sound absorbing ratios of wall materials and air absorption with respect to a direct sound and reflected sounds arriving at the sound receiving point, and
(3) Arrival delay time data of a direct sound and reflected sounds arriving at the sound receiving point from the sound source.

Either data calculated by software for acoustic simulation or data of a pseudo-acoustic filed created by a user enables to be applied for the above-mentioned data. In other words, any kind of data enables to be applied for the above-mentioned data as far as the data include information about reflected sounds, which is a set of information about incoming directions of reflected sounds, frequency responses of the reflected sounds and arrival delay times of the reflected sounds.

When the above-mentioned three data of whole reflected sounds including direct sounds are calculated, the process is shifted to a step of producing impulse responses. Firstly, the producing section 4 resets a number (i) of processes to zero, that is, “i=0” (S3), and then a direct sound is processed first. The selecting section 41 obtains a pair of right and left head transfer functions, which corresponds to data of a horizontal angle and an elevation angle with respect to the direct sound, from the storage section 5 (S4 and S5). The equalizing section 42 equalizes the respective pair of right and left head transfer functions obtained by the selecting section 5 per each frequency range by using frequency characteristic data of the direct sound (S6). The pair of right and left head transfer functions is processed through an FIR (finite impulse response) filter on the basis of 70 dB as a reference, for example. It shall be understood that any level other than 70 dB or any filter other than FIR filter is applicable for processing the pair of right and left head transfer functions.

The delaying section 43 delays the equalized pair of right and left head transfer functions by delay time on the basis of the arrival delay time data of the direct sound calculated in the step S2 (S7). Then, the adding section 44 keeps the pair of right and left head transfer functions by which the direct sound is replaced (S8).

The number (i) of processes is increased by one, in this case “i=1” (S9), and a first reflected sound is processed (S10). The first reflected sound is forwarded to a “Yes” direction in the step S10 because the number “i” is less than the total number of reflected sounds, and fed back to the step S4. In the steps S4 and 5, the selecting section 41 selects a corresponding pair of right and left head transfer functions as the same manner as processing the direct sound, and the pair of right and left head transfer functions is equalized in the equalizing section 42 (S6). In this equalizing process, the pair of right and left head transfer functions corresponding to the first reflected sound is processed on the basis of 70 dB as the same reference level as for the direct sound mentioned above. After the equalized pair of right and left head transfer functions is delayed by the delaying section 43 (S7), in the adding section 44, each of the pair of right and left head transfer functions of the direct sound, which is kept in the adding section 44, is added to each of the pair of right and left head transfer functions of the first reflected sound respectively (S8). In this connection, a reflected sound arrives at a sound receiving point later than a direct sound, so that the reflected sound is added to the direct sound at a timing later than the direct sound a little.

By this means, head transfer functions equivalent to whole reflected sounds or a total number of sound rays are accumulated and a pair of right and left impulse responses is produced. When processing whole reflected sounds is completed, the pair of right and left impulse responses is forwarded to a “No” direction in the step S10. By this process, the produced pair of right and left impulse responses is equivalent to impulse responses at right and left ears of the human head disposed at the sound receiving point.

In case music recorded inside an anechoic chamber is convoluted into an impulse response of a room, generally, it is commonly known that an acoustic field of the room results in an acoustic field when listening to the music in the room. The making audible section 6 convolutes a monaural source and right and left impulse responses respectively in case a sound source is just one (S11). In case an output device of the audio I/O section 2 is a loudspeaker, the making audible section 6 performs a crosstalk canceling process while crosstalk between two loudspeakers allocated in a reproducing ambience is previously measured (S11).

Further, in case an output device of the audio I/O section 2 is a headphone, an inverse characteristic of the headphone is processed through a filter such that a transfer function from a loudspeaker built in the headphone to an ear becomes one (S1). Consequently, the processed audio signals are supplied to the loudspeaker or the headphone, and whole reflected sounds including direct sounds are reproduced such that they are heard from appropriate arriving directions.

As mentioned above, according to the first embodiment of the present invention, head transfer functions in whole directions are utilized. Therefore, all sounds arriving from whole directions enable to be reproduced in comparison with the conventional reproducing method in which only sounds arriving from a loudspeaker allocating direction enable to be reproduced.

Consequently, according to the first embodiment of the present invention, an acoustic field in higher realistic sensations enables to be reproduced.

Further, an acoustic field enables to be reproduced more accurately because arrival delay time at a sound receiving point enables to be reproduced faithfully.

[Second Embodiment]

An apparatus for creating all-around acoustic field according to a second embodiment of the present invention is exhibited next. Necessary data for conducting the present invention are supplied to the apparatus of the second embodiment from a medium such as a CD-EXTRA disc. The data activate the apparatus to be operated when a user intends to listen to an acoustic field of a concert hall. Consequently, the apparatus of the second embodiment enables to be regarded as a CD-EXTRA player.

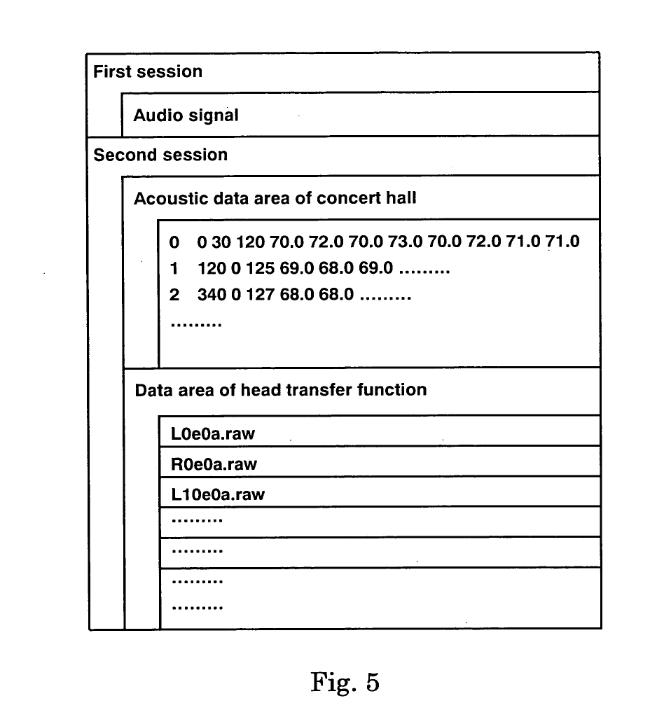

FIG. 5 shows a format of a CD-EXTRA disc according to a second embodiment of the present invention. The format is provided with acoustic data area of a concert hall and data area of head transfer functions other than regular music data or audio signals. The acoustic data area of a concert hall is written with a sequence number of a reflected sound such that a direct sound is numbered zero and a reflected sound is numbered one and up, data of arriving directions in a horizontal angle and an elevation angle, data of arrival delay time, and data of frequency characteristics.

In case of listening to an acoustic field of a concert hall, an acoustic data area and a data area of head transfer functions are written in a built in memory not shown, and then a pair of right and left impulse responses is produced as the same processes as detailed in the first embodiment. The impulse responses are convoluted with audio signals recorded in a CD-EXTRA disc and conducted through a crosstalk canceling process by using previously measured crosstalk data.

In the meanwhile, recently, audio signals recorded in a CD-EXTRA disc are stereophonic signals in general. In this case, a sound source is defined as two, right (R) and left (L), as commonly known. Information about reflected sounds is calculated in accordance with a first case in which a monaural sound source is allocated in the R and a second case in which a monaural sound source is allocated in the L individually. Then, acoustic field analyzing data in two channels are obtained. In other words, two pairs of right and left impulse responses are produced such as a first pair of right and left impulse responses according to the first case and a second pair of right and left impulse responses according to the second case.

Further, with respect to an convolution operation, an R channel signal of the stereophonic audio signal is convoluted to the first pair of right and left impulse responses respectively when the loudspeaker is allocated in the R. An L channel signal of the stereophonic audio signal is convoluted to the second pair of right and left impulse responses respectively when the loudspeaker is allocated in the L. Then, respective signals are added such that the convoluted right impulse response signal of the first pair of right and left impulse response signals is added to the convoluted right impulse response signal of the second pair of right and left impulse response signals, and the convoluted left impulse response signal of the first pair of right and left impulse response signals is added to the convoluted left impulse response signal of the second pair of right and left impulse response signals.

[Third Embodiment]

An apparatus for creating all-around acoustic field according to a third embodiment of the present invention is exhibited next. A medium supplying necessary data for conducting the present invention is a DVD-Audio disc. Consequently, the apparatus for creating all-around acoustic field according to the third embodiment enables to be regarded as a DVD-Audio player.

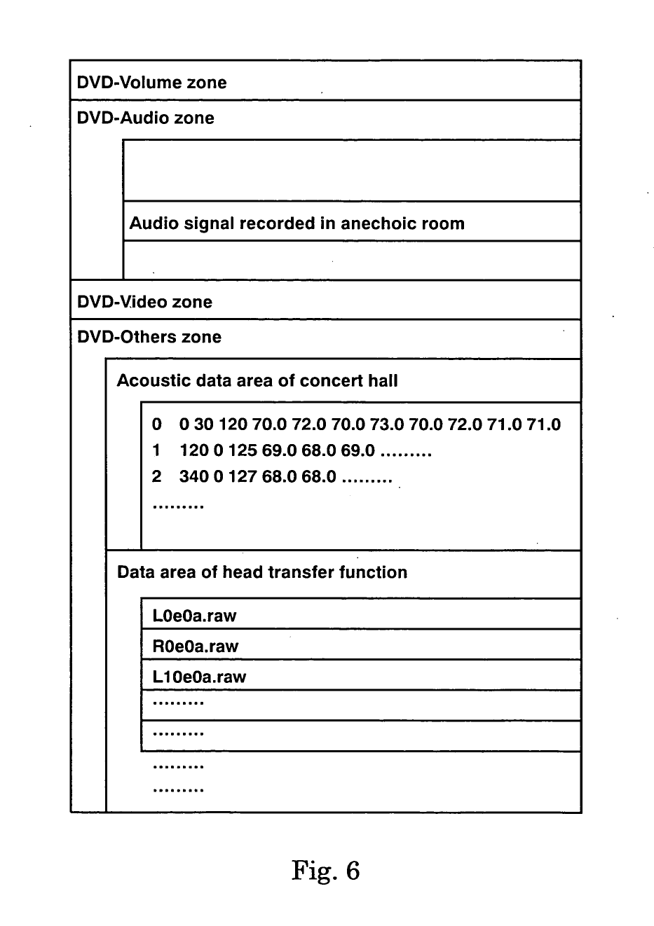

FIG. 6 shows a program configuration of a DVD-AUDIO disc according to a third embodiment of the present invention.

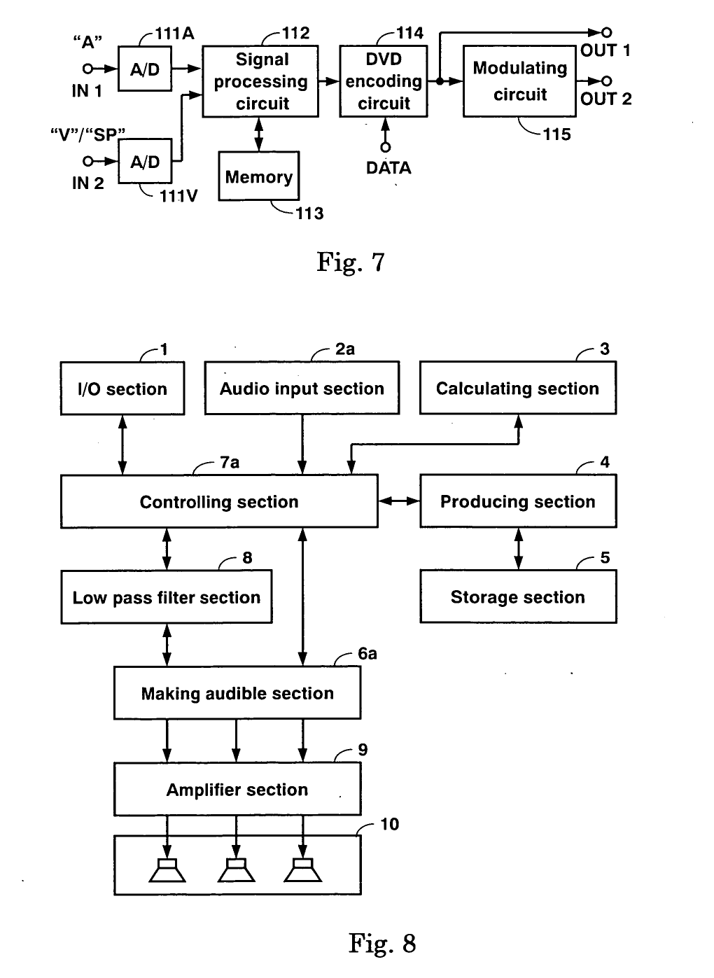

FIG. 7 is a block diagram of a DVD encoder applied for the apparatus for creating all-around acoustic field according to the third embodiment of the present invention.

As shown in FIG. 6, a DVD-Audio disc format is composed of a DVD-Audio zone containing audio signals and a DVD-Others zone accomplishing the same functions as a DVD-ROM. A DVD-Audio disc enables to be recorded with a same sound source in maximal two types of audio formats. In the case of an audio signal to be recorded on a DVD-Audio disc according to the third embodiment of the present invention, two types of audio signals are recorded on a DVD-Audio disc: one is a signal of music that is recorded by a regular recording method and mixed down, and the other is another signal of the same music that is performed and recorded in an anechoic chamber. In case recording in an anechoic chamber is not conducted, it is acceptable to record only a direct sound and mix down by setting a microphone near an instrument on a stage in a concert hall.

On the other hand, the DVD-Others zone enables to be recorded with not only data but also a program. Consequently, a program for creating an all-around acoustic field according to the present invention, acoustic data of a concert hall and data of head transfer functions are recorded in the DVD-Others zone of a DVD-Audio disc.

When a DVD-Audio disc recorded with the above-mentioned program and data is loaded in the apparatus for creating an all-around acoustic field according to the present invention and an operation button is pressed so as to listen music in an acoustic field of a concert hall, the program for creating an all-around acoustic field recorded in the DVD-Others zone is read into a RAM area of the apparatus or a DVD-Audio player first. Then, the acoustic data of a concert hall and the data of head transfer functions are read in succeedingly, and finally the method for creating an all-around acoustic field begins to operate.

As mentioned above, by using a recording medium described in the second and third embodiments of the present invention, it is not necessary for a user to provide acoustic data of a concert hall, data of head transfer functions or a program at all. A user easy enables to enjoy an acoustic field of a concert hall high in accuracy.

Further, it should be understood that such a recording medium is not limited to a CD-EXTRA disc or a DVD-Audio disc. A memory card or a magnetic disc is acceptable for such a recording medium.

FIG. 7 is a block diagram of a DVD encoder applied with the present invention. In FIG. 7, a DVD encoder is composed of an A/D converter 111A for an audio signal “A”, another A/D converter 111V for a video signal “V” or a still picture signal “SP”, a signal processing circuit 112, a memory 113, a DVD encoding circuit 114, and a modulating circuit 115. An audio signal “A” supplied to an input terminal IN1 is converted into a digital audio signal by the A/D converter 111A and supplied to the signal processing circuit 112. The signal processing circuit 112 outputs the digital audio signal as it is to the DVD encoding circuit 114 in case the digital audio signal is not compressed. On the contrary, in case the digital audio signal is compressed, the signal processing circuit 112 compresses the digital audio signal, and then outputs to the DVD encoding circuit 114.

On the other hand, a video signal “V” or still picture signal “SP” supplied to an input terminal IN2 is converted into a digital video or digital still picture signal respectively by the other A/D converter 111V and supplied to the signal processing circuit 112. The signal processing circuit 112 encodes the digital video signal onto the MPEG format and outputs to the DVD encoding circuit 114. On the other hand, the signal processing circuit 112 encodes the digital still picture signal onto the MPEG format or the JPEG format and outputs to the DVD encoding circuit 114.

The DVD encoding circuit 114 formats the audio signal “A”, the video signal “V”, the still picture signal “SP”, the acoustic data of a concert hall and the data of head transfer functions into the data configuration shown in FIG. 6, wherein the acoustic data of a concert hall and the data of head transfer functions are inputted to a “DATA” terminal. These formatted stream data are outputted as it is through an output terminal OUT1 or modulated by the modulating circuit 115 in accordance with a medium to be recorded and outputted through an output terminal OUT2. The stream data outputted through the output terminal OUT1 are transmitted through a network such as Internet and data broadcasting.

The DVD encoding circuit 114 corresponds to the sections 3, 4, 5 and 7 shown in FIG. 1 of the apparatus for creating an all-around acoustic field according to the first embodiment of the present invention.

Further, the DVD encoding circuit 114 corresponds to sections 3, 4, 5, 7a and 8 shown in FIG. 8 of an apparatus for creating an all-around acoustic field according to a fourth embodiment of the present invention to be detailed next.

[Fourth Embodiment]

FIG. 8 is a block diagram of an apparatus for creating an all-around acoustic field according to a fourth embodiment of the present invention.

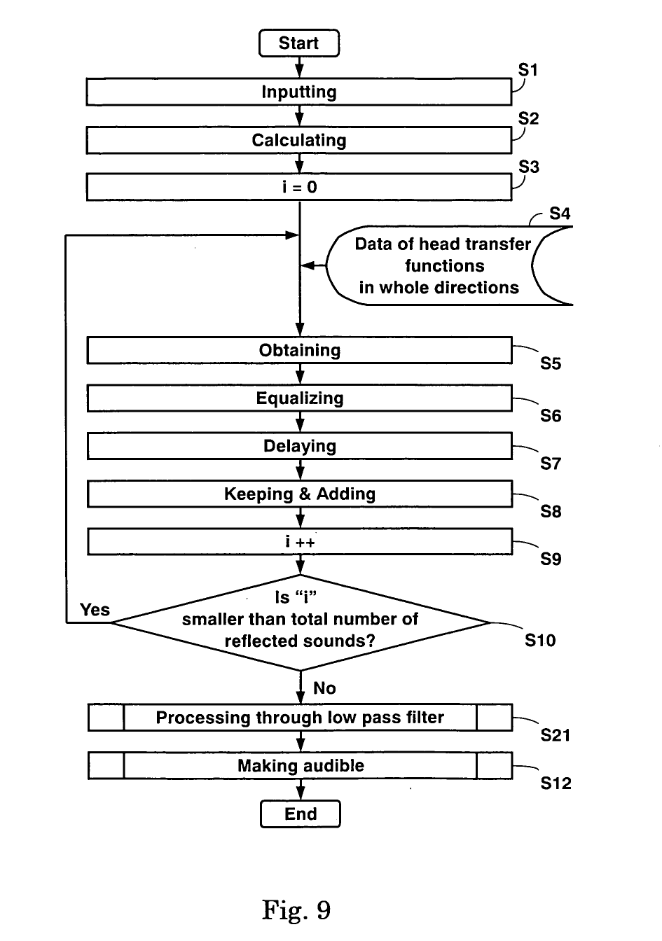

FIG. 9 is a flow chart showing total processes conducted in the apparatus shown in FIG. 8.

With referring to FIGS. 8 and 9, an apparatus for creating an all-around acoustic field according to a fourth embodiment of the present invention is explained next. The apparatus according to the fourth embodiment is identical to the apparatus according to the first embodiment except for an audio input section 2a, a low pass filter section 8, an amplifier section 9 and an audio outputting section 10. Thus, in FIGS. 8 and 9, the same reference signs are given to the same sections and processing steps as shown in FIGS. 1 and 3, and their details are omitted. The apparatus according to the fourth embodiment is provided with an exclusive channel for low frequencies, so that the apparatus enables to reproduce such a so-called situation that sounds transmit throughout a concert hall and the concert hall resonates totally as if the concert hall transformed into a resonance box or a resonator. In other word, the apparatus enables to reproduce a situation of sounding all-around.

In FIG. 8, reference signs 2a, 6a, 7a and 8 to 10 denote an audio input section, a making audible section, a controlling section, a low pass filter section, an amplifier section and an audio outputting section respectively. The audio input section 2a is an input device necessary for sounds when making them audible. A number of input channels is one in case a sound source is designated to be one. In case a sound source is designated to be two, a number of input channels is two.

The low pass filter section 8 fetches out each low frequency component from two channels of right and left impulse responses that are produced by the producing section 4. Each of the fetched out low frequency components is added, and results in producing an impulse response of a low frequency component. The making audible section 6a makes audio signals inputted by the audio input section 2a audible by using right and left impulse responses and the impulse response of a low frequency component, wherein the making audible section 6a is an acoustic field processing section for processing inputted audio signals. The controlling section 7a controls these sections. The right, left and low frequency signals processed through the acoustic field processing conducted by the making audible section 6a are amplified by the amplifier section 9 and outputted through the audio outputting section 10.

With referring to FIGS. 8, 9 and 2, further details are exhibited hereinafter.

First of all, in order to configure a chamber shape of an objective concert hall, that is, a space to be an object of reproducing an acoustic field, chamber shape data and data of sound absorbing ratios of interior materials furnished on wall surfaces are inputted through the I/O section 1 (a step S1 in FIG. 9), wherein a sound source and a sound receiving point is defined as only one respectively. When inputting all data necessary for obtaining information about reflected sounds is completed, the controlling section 7a conducts the calculating section 3 to calculate a reflected sound at the sound receiving point. In this fourth embodiment, the calculating section 3 calculates all sound rays arriving at the sound receiving point from the sound source based on the geometrical acoustics. In this bout, following three kinds of data or acoustic field analyzing data are calculated (S2):
(1) Arriving directions of a direct sound and reflected sounds arriving at the sound receiving point, that is, data of a horizontal angle and an elevation angle,
(2) Frequency characteristic data reflecting sound absorbing ratios of wall materials and air absorption with respect to a direct sound and reflected sounds arriving at the sound receiving point, and
(3) Arrival delay time data of a direct sound and reflected sounds arriving at the sound receiving point from the sound source.

Either data calculated by software for acoustic simulation or data of a pseudo-acoustic filed, created by a user, enables to be applied for the above-mentioned data. In other words, any kind of data enables to be applied for the above-mentioned data as far as the data include information about reflected sounds, which is a set of information about incoming directions of reflected sounds, frequency responses of the reflected sounds and arrival delay times of the reflected sounds.

When the above-mentioned three data of whole reflected sounds including direct sounds are calculated, the process is shifted to a step of producing impulse responses. Firstly, the producing section 4 resets a number (i) of processes to zero, that is, “i=0” (S3), and then a direct sound is processed first. The selecting section 41 obtains a pair of right and left head transfer functions, which corresponds to data of a horizontal angle and an elevation angle with respect to the direct sound, from the storage section 5 (S4 and S5). The equalizing section 42 equalizes the respective pair of right and left head transfer functions obtained by the selecting section 5 per each frequency range by using frequency characteristic data of the direct sound (S6). The pair of right and left head transfer functions is processed through an FIR (finite impulse response) filter on the basis of 70 dB as a reference, for example. It shall be understood that any level other than 70 dB or any filter other than FIR filter is applicable for processing the pair of right and left head transfer functions.

The delaying section 43 delays the equalized pair of right and left head transfer functions by delay time on the basis of the arrival delay time data of the direct sound calculated in the step S2 (S7). Then, the adding section 44 keeps the pair of right and left head transfer functions by which the direct sound is replaced (S8).

The number (i) of processes is increased by one, in this case “i=1” (S9), and a first reflected sound is processed (S10). The first reflected sound is forwarded to a “Yes” direction in the step S10 because the number “i” is less than the total number of reflected sounds, and fed back to the step S4. In the steps S4 and 5, the selecting section 41 selects a corresponding pair of right and left head transfer functions as the same manner as processing the direct sound, and the pair of right and left head transfer functions is equalized in the equalizing section 42 (S6). In this equalizing process, the pair of right and left head transfer functions corresponding to the first reflected sound is processed on the basis of 70 dB as the same reference level as for the direct sound mentioned above. After the equalized pair of right and left head transfer functions is delayed by the delaying section 43 (S7), in the adding section 44, each of the pair of right and left head transfer functions of the direct sound, which is kept in the adding section 44, is added to each of the pair of right and left head transfer functions of the first reflected sound respectively (S8). In this connection, a reflected sound arrives at a sound receiving point later than a direct sound, so that the reflected sound is added to the direct sound at a timing later than the direct sound a little.

By this means, head transfer functions equivalent to whole reflected sounds or a total number of sound rays are accumulated and a pair of right and left impulse responses is produced. When processing whole reflected sound is completed, the pair of right and left impulse responses is forwarded to a “No” direction in the step S10. By this process, the produced pair of right and left impulse responses is equivalent to impulse responses at right and left ears of the human head disposed at the sound receiving point.

Succeedingly, in a step S21, each low frequency component of two channels of right and left impulse responses is fetched out by the low pass filter section 8, wherein the low frequency component is defined as a low frequency band lower than 100 Hz. Each of the low frequency components is added, and an impulse response of a low frequency is produced (S21).

In case music recorded inside an anechoic chamber is convoluted into an impulse response of a room, generally, it is commonly known that an acoustic field of the room results in an acoustic field when listening to the music in the room. The making audible section 6a convolutes a monaural source and right and left impulse responses, and the monaural source and right and left impulse responses of the low frequency component respectively in case a sound source is just one (S12). In case the audio outputting section 10 is a loudspeaker, crosstalk between two loudspeakers allocated in a reproducing ambience is previously measured, and right and left two channel signals are reproduced through right and left loudspeakers in the front after canceling crosstalk. The low frequency signal convoluted with the monaural source and the impulse response of the low frequency component is reproduced through a subwoofer (S12).

It is also applicable that the low pass filter section 8 is allocated in a section succeeding the making audible section 6a and a low frequency component is fetched out from a signal convoluted with an impulse response.

Further, in case the audio outputting section 10 is a headphone, an inverse characteristic of the headphone is processed through a filter such that a transfer function from a loudspeaker built in the headphone to an ear becomes one (S12). In this case, the low frequency signal is outputted through both the right and left loudspeakers.

As mentioned above, the processed audio signals are supplied to loudspeakers or a headphone, and then reflected sounds including a direct sound are reproduced in appropriate arriving directions.

According to the fourth embodiment of the present invention, head transfer functions in whole directions are utilized. Therefore, all sounds arriving from whole directions enable to be reproduced in comparison with the conventional reproducing method in which only sounds arriving from a loudspeaker allocating direction enable to be reproduced.

Further, enhancing low frequencies, which are said to exclude directional character, by reproducing through a subwoofer enables to produce a situation such that sounds transmit throughout a concert hall and the concert hall resonates totally as if the concert hall transformed into a resonance box or a resonator, that is, a situation of sounding all-around.

Consequently, according to the fourth embodiment of the present invention, an acoustic field in higher realistic sensations enables to be reproduced.

Furthermore, an acoustic field enables to be reproduced more accurately because arrival delay time at a sound receiving point enables to be reproduced faithfully.

More, it should be understood that the present invention comprehends a program, which is utilized for realizing functions of the above-mentioned apparatus for creating an all-around acoustic field by a computer. The program enables to be installed into a computer by reading out from a recording medium or by being transmitted through a communication network.

As mentioned above, the apparatus, the method, and the program for creating an all-around acoustic field according to the present invention possesses the database of head transfer functions. Therefore, conditions of a sound receiving point are extremely high in accuracy when making sound signals audible. Consequently, by combining with the “Sound Simulation Device and Sound Controller” disclosed in the Japanese Patent Application Laid-open Publication No. 2002-366162 of which conditions of a sound source are extremely high in accuracy, reproducing an acoustic field high in accuracy furthermore enables to be realized.

According to an aspect of the present invention, there provided an apparatus, a method, and a program for creating an all-around acoustic field, which enables to reproduce arriving directions of reflected sounds in whole directions as well as a direct sound in a specific acoustic field such as a concert hall by a method and procedures improved furthermore such as shortening processing time, and resulting in reproducing an acoustic field in higher realistic sensations.

Further, according to the apparatus, the method, and the program for creating an all-around acoustic field of the present invention, arrival delay time at a sound receiving point enables to be reproduced faithfully, and resulting in reproducing an acoustic field high in accuracy.

Furthermore, assigning low frequencies, which are said to exclude directional character, to be an exclusive channel, enables to reproduce a situation such that sounds transmit throughout a concert hall and the concert hall resonates totally as if the concert hall transformed into a resonance box or a resonator, that is, a situation of sounding all-around.

It will be apparent to those skilled in the art that various modifications and variations could be made in the apparatus, the method, and the program for creating an all-around acoustic field in the present invention without departing from the scope of the invention.

1. An apparatus for creating an all-around acoustic field, producing an acoustic field with respect to incoming audio-signals on the basis of analyzed data of an acoustic field at a sound receiving point designated in a space to be objected for reproducing the acoustic field, comprising:
storage means for storing data of head transfer functions in whole directions at respective positions of both ears of a human head;
producing means for producing two channels of right and left impulse responses by replacing a direct sound and each reflected sound at the sound receiving point with a pair of right and left head transfer functions by using the analyzed data of an acoustic field and the data of head transfer functions in whole directions; and
acoustic field processing means for processing to reproduce an acoustic field with respect to the incoming audio signals by using the two channels of right and left impulse responses produced by the producing means,
the producing means further characterized by comprising;
selecting means for selecting data of one pair of right and left head transfer functions of the direct sound at an angle corresponding to an arriving direction of the direct sound out of the data of head transfer functions in whole directions on the basis of data of arriving directions of direct sounds as the analyzed data of an acoustic field at the sound receiving point, and for selecting data of a pair of right and left head transfer functions with respect to the each reflected sound at an angle corresponding to an arriving direction of the each reflected sound out of the data of head transfer functions in whole directions on the basis of data of arriving directions of each reflected sound as the analyzed data of an acoustic field at the sound receiving point;
equalizing means for equalizing the pair of right and left head transfer functions selected by the selecting means with respect to the selected direct sound on the basis of data of frequency characteristics of a direct sound at the sound receiving point as the analyzed data of an acoustic field, and for equalizing the selected pair of right and left head transfer functions with respect to the selected each reflected sound on the basis of the data of frequency characteristics of a reflected sound at the sound receiving point as the analyzed data of an acoustic field;
delaying means for delaying a pair of right and left head transfer functions with respect to the equalized direct sound on the basis of data of arrival delay time of a direct sound at the sound receiving point as the analyzed data of an acoustic field, and for delaying a pair of right and left head transfer functions with respect to the equalized each reflected sound on the basis of data of arrival delay time of a reflected sound at the sound receiving point as the analyzed data of an acoustic field; and
adding means for obtaining the two channels of right and left impulse responses by adding the delayed data of the pair of right and left head transfer functions obtained with respect to the direct sound to the delayed data of the pair of head transfer functions obtained with respect to the each reflected sound equivalent to a number of sound rays of reflected sounds in each of the right and left channels respectively.

2. The apparatus for creating an all-around acoustic field in accordance with claim 1, further comprising low pass filter means for fetching out only respective low frequency components of the two channels of right and left impulse responses produced by the producing means and for producing impulse responses of low frequency components by adding each of the fetched out respective low frequency components,
the apparatus further characterized in that the acoustic field processing means processes to reproduce an acoustic field with respect to the incoming audio signals by using the two channels of right and left impulse responses and the impulse responses of the low frequency components.

3. A method for creating an all-around acoustic field, producing an acoustic field with respect to incoming audio signals on the basis of analyzed data of an acoustic field at a sound receiving point designated in a space to be objected for reproducing the acoustic field, comprising steps of:
storing data of head transfer functions in whole directions at respective positions of both ears of a human head;
producing two channels of right and left impulse responses by replacing a direct sound and each reflected sound at the sound receiving point with a pair of right and left head transfer functions by using the analyzed data of an acoustic field and the data of head transfer functions in whole directions; and
processing to reproduce an acoustic field with respect to the incoming audio signals by using the two channels of right and left impulse responses produced in the step of producing,
the step of producing the two channels of right and left impulse responses further characterized by comprising steps of:
selecting data of one pair of right and left head transfer functions of the direct sound at an angle corresponding to an arriving direction of the direct sound out of the data of head transfer functions in whole directions on the basis of data of arriving directions of direct sounds as the analyzed data of an acoustic field at the sound receiving point, and for selecting data of a pair of right and left head transfer functions with respect to the each reflected sound at an angle corresponding to an arriving direction of the each reflected sound out of the data of head transfer functions in whole directions on the basis of data of arriving directions of each reflected sound as the analyzed data of an acoustic field at the sound receiving point;
equalizing the pair of right and left head transfer functions selected in the step of selecting with respect to the selected direct sound on the basis of data of frequency characteristics of a direct sound at the sound receiving point as the analyzed data of an acoustic field, and for equalizing the selected pair of right and left head transfer functions with respect to the selected each reflected sound on the basis of the data of frequency characteristics of a reflected sound at the sound receiving point as the analyzed data of an acoustic field;
delaying a pair of right and left head transfer functions with respect to the equalized direct sound on the basis of data of arrival delay time of a direct sound at the sound receiving point as the analyzed data of an acoustic field, and for delaying a pair of right and left head transfer functions with respect to the equalized each reflected sound on the basis of data of arrival delay time of a reflected sound at the sound receiving point as the analyzed data of an acoustic field; and
adding to obtain the two channels of right and left impulse responses by adding the delayed data of the pair of right and left head transfer functions obtained with respect to the direct sound to the delayed data of the pair of head transfer functions obtained with respect to the each reflected sound equivalent to a number of sound rays of reflected sounds in each of the right and left channels respectively.

4. The method for creating an all-around acoustic field in accordance with claim 3, further comprising a step of passing low frequencies for fetching out only respective low frequency components of the two channels of right and left impulse responses produced in the step of producing and for producing impulse responses of low frequency components by adding each of the fetched out respective low frequency components,
the method further characterized in that the step of processing processes to reproduce an acoustic field with respect to the incoming audio signals by using the two channels of right and left impulse responses and the impulse responses of the low frequency components.

5. A program for creating an all-around acoustic field, making a computer function as an apparatus for creating an all-around acoustic field for producing an acoustic field with respect to incoming audio signals on the basis of analyzed data of an acoustic field at a sound receiving point designated in a space to be objected for reproducing the acoustic field, wherein the computer is realized by the program to comprise:
producing means for producing two channels of right and left impulse responses by replacing a direct sound and each reflected sound at the sound receiving point with a pair of right and left head transfer functions by using data of head transfer functions supplied from a memory storing the analyzed data of an acoustic field and data of head transfer functions in whole directions at respective positions of both ears of a human head; and
acoustic field processing means for processing to reproduce an acoustic field with respect to the incoming audio signals by using the two channels of right and left impulse responses produced by the producing means,
the producing means further characterized by comprising:
selecting means for selecting data of one pair of right and left head transfer functions of the direct sound at an angle corresponding to an arriving direction of the direct sound out of the data of head transfer functions in whole directions on the basis of data of arriving directions of direct sounds as the analyzed data of an acoustic field at the sound receiving point, and for selecting data of a pair of right and left head transfer functions with respect to the each reflected sound at an angle corresponding to an arriving direction of the each reflected sound out of the data of head transfer functions in whole directions on the basis of data of arriving directions of each reflected sound as the analyzed data of an acoustic field at the sound receiving point;
equalizing means for equalizing the pair of right and left head transfer functions selected by the selecting means with respect to the selected direct sound on the basis of data of frequency characteristics of a direct sound at the sound receiving point as the analyzed data of an acoustic field, and for equalizing the selected pair of right and left head transfer functions with respect to the selected each reflected sound on the basis of the data of frequency characteristics of a reflected sound at the sound receiving point as the analyzed data of an acoustic field;
delaying means for delaying a pair of right and left head transfer functions with respect to the equalized direct sound on the basis of data of arrival delay time of a direct sound at the sound receiving point as the analyzed data of an acoustic field, and for delaying a pair of right and left head transfer functions with respect to the equalized each reflected sound on the basis of data of arrival delay time of a reflected sound at the sound receiving point as the analyzed data of an acoustic field; and
adding means for obtaining the two channels of right and left impulse responses by adding the delayed data of the pair of right and left head transfer functions obtained with respect to the direct sound to the delayed data of the pair of head transfer functions obtained with respect to the each reflected sound equivalent to a number of sound rays of reflected sounds in each of the right and left channels respectively.

6. The program for creating an all-around acoustic field in accordance with claim 5, further making the computer realize to comprise low pass filter means for fetching out only respective low frequency components of the two channels of right and left impulse responses produced by the producing means and for producing impulse responses of low frequency components by adding each of the fetched out respective low frequency components,
the program further characterized in that the acoustic field processing means processes to reproduce an acoustic field with respect to the incoming audio signals by using the two channels of right and left impulse responses and the impulse responses of the low frequency components.
